(19) United States
(12) Patent Application Publication
(10) Pub. No.: US 2023/0286284 A1
(43) Pub. Date: Sep. 14, 2023

(54) IMAGE RECORDING APPARATUS AND STORAGE MEDIUM STORING CONSUMABLE ORDER PROCESSING PROGRAM

(71) Applicant: BROTHER KOGYO KABUSHIKI KAISHA, Nagoya (JP)

(72) Inventor: Hironori TAKASAKI, Ogaki (JP)

(73) Assignee: BROTHER KOGYO KABUSHIKI KAISHA, Nagoya (JP)

(21) Appl. No.: 18/163,335

(22) Filed: Feb. 2, 2023

(30) Foreign Application Priority Data
Mar. 14, 2022 (JP) 2022-039662

(51) Int. Cl. B41J 2/175; G06Q 10/087; B41J 2/17

(52) U.S. Cl. CPC B41J 2/17566; G06Q 10/087; B41J 2/1721

(57) ABSTRACT

A controller performs: determining which of a first state, a second state, and a third state a consumption level of a first consumable corresponds to; determining which of a fourth state, a fifth state, and a sixth state a consumption level of a second consumable corresponds to; and in a case where the first consumable becomes the third state before the second consumable becomes the sixth state, selectively performing an order process or a non-order process for first and second consumables based on determination results. The selectively performing the order process or the non-order process includes: in a case where the second consumable is in the fourth state, performing the order process for the first consumable and performing the non-order process for the second consumable; and in a case where the second consumable is in the fifth state, performing the order process for the first and second consumables.

### REFERENCE TO RELATED APPLICATIONS

This application claims priority from Japanese Patent Application No. 2022-039662 filed on Mar. 14, 2022. The entire content of the priority application is incorporated herein by reference.

### BACKGROUND ART

In an automatic consumable ordering system, a consumption level of consumables such as ink and recording mediums is transmitted from an image recording apparatus to a management server.

### DESCRIPTION

When a consumption state amount representing the consumption level reaches a threshold, an order request is transmitted from the management server to a store server, and the store server that has received the order request ships a consumable to a user.

In this case, every time the consumption state amount of each consumable of an image recording apparatus reaches the corresponding threshold, consumables are delivered to the user one after another, and it is cumbersome and a burden for the user to receive and manage the consumables.

In view of the foregoing, an example of an object of this disclosure is to provide an image recording apparatus and a storage medium storing a consumable order processing program configured to reduce a user's burden by enabling simultaneous order of a plurality of consumables.

According to one aspect, this specification discloses an image recording apparatus. The image recording apparatus includes a print engine, at least two consumables, and a controller. The print engine is configured to record an image on a recording medium. The at least two consumables include a first consumable and a second consumable. The controller is configured to perform: determining which of a first state, a second state, and a third state a consumption level of the first consumable corresponds to, a consumption level of the second state being higher than the consumption level of the first state, a consumption level of the third state being higher than the consumption level of the second state; determining which of a fourth state, a fifth state, and a sixth state a consumption level of the second consumable corresponds to, a consumption level of the fifth state being higher than the consumption level of the fourth state, a consumption level of the sixth state being higher than the consumption level of the fifth state; and in a case where the first consumable becomes the third state before the second consumable becomes the sixth state, selectively performing an order process or a non-order process for the first consumable and the second consumable based on determination results of the consumption level of the first consumable and the consumption level of the second consumable. The selectively performing the order process or the non-order process includes: in a case where the second consumable is in the fourth state, performing the order process for the first consumable and performing the non-order process for the second consumable; and in a case where the second consumable is in the fifth state, performing the order process for the first consumable and performing the order process for the second consumable.

With this configuration, when the second consumable is consumed to some extent at the time when the order process for the first consumable greatly consumed is to be executed, even when the consumption levels of the first consumable and the second consumable are not identical to each other, the order process for the second consumable is also executed concurrently. Since the first consumable and the second consumable are concurrently ordered and delivered, the burden on the user is reduced compared to the case where the second consumable is delivered at another timing after the first consumable is delivered.

According to another aspect, a controller is configured to: in a case where the first consumable becomes the third state before the second consumable becomes the sixth state, selectively perform a display process or a non-display process in an order screen of the display for the first consumable and the second consumable based on determination results of the consumption level of the first consumable and the consumption level of the second consumable. The selectively performing the display process or the non-display process includes: in a case where the second consumable is in the fourth state, performing the display process for the first consumable and performing the non-display process for the second consumable; and in a case where the second consumable is in the fifth state, performing the display process for the first consumable and performing the display process for the second consumable.

The technique disclosed in this specification may be implemented in various modes, and may be realized in forms such as an apparatus, a method, and a computer program for realizing the functions of the apparatus or method, a non-transitory computer-readable storage medium storing the computer program, and so on.

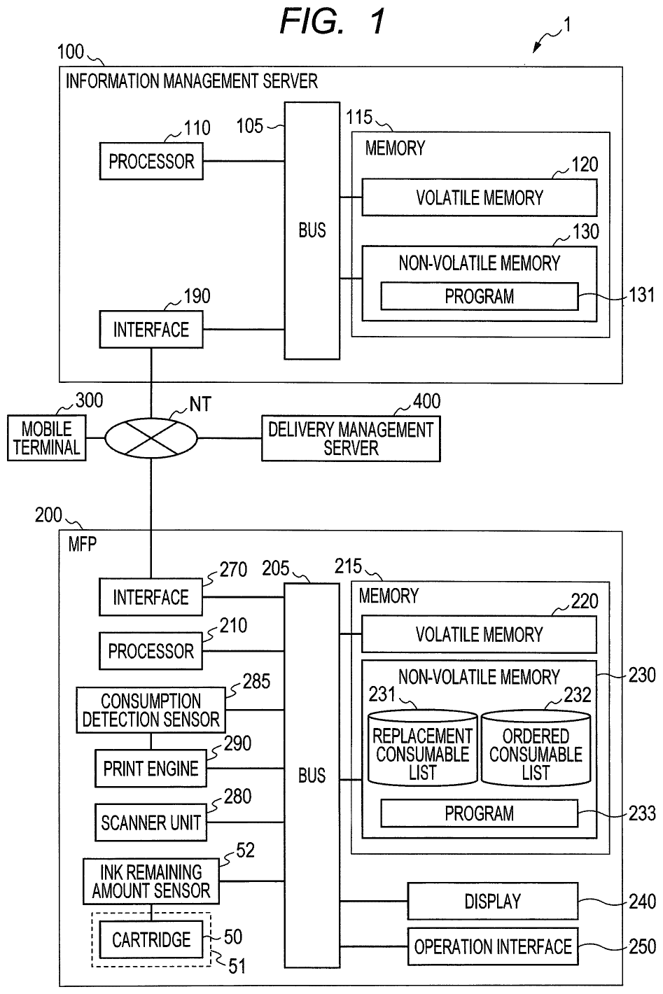

FIG. 1 is a functional block diagram showing an overall schematic configuration of a print processing system.

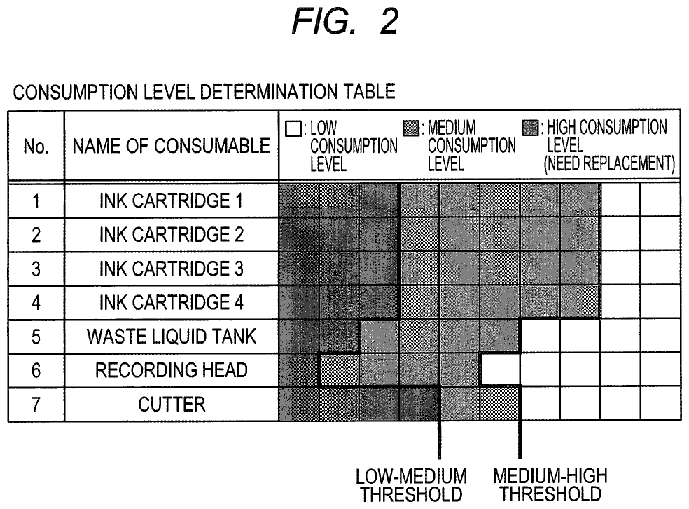

FIG. 2 is a diagram schematically showing a consumption level determination table.

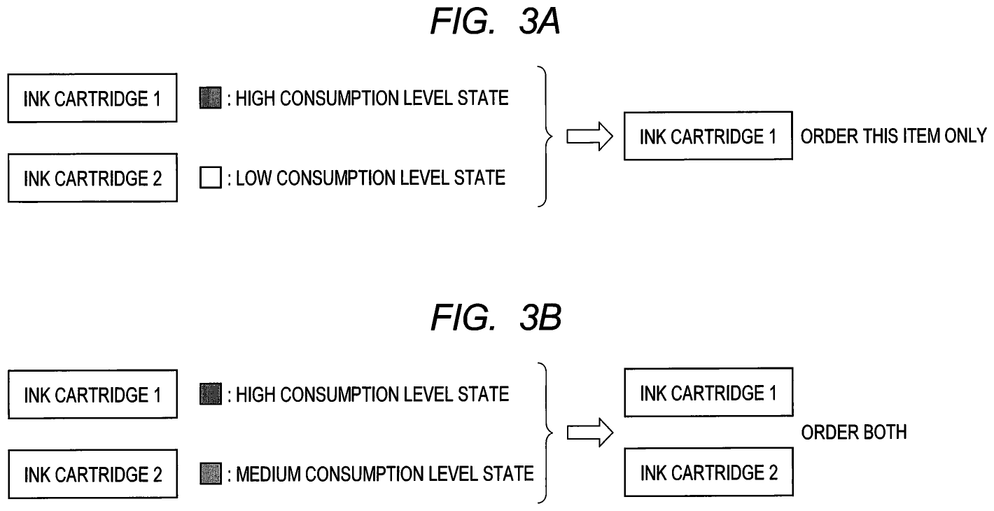

FIG. 3A is a diagram for explaining a case of placing an order individually depending on a combination of a consumption level state of each of two consumables.

FIG. 3B is a diagram for explaining a case of placing an order collectively depending on a combination of the consumption level state of each of two consumables.

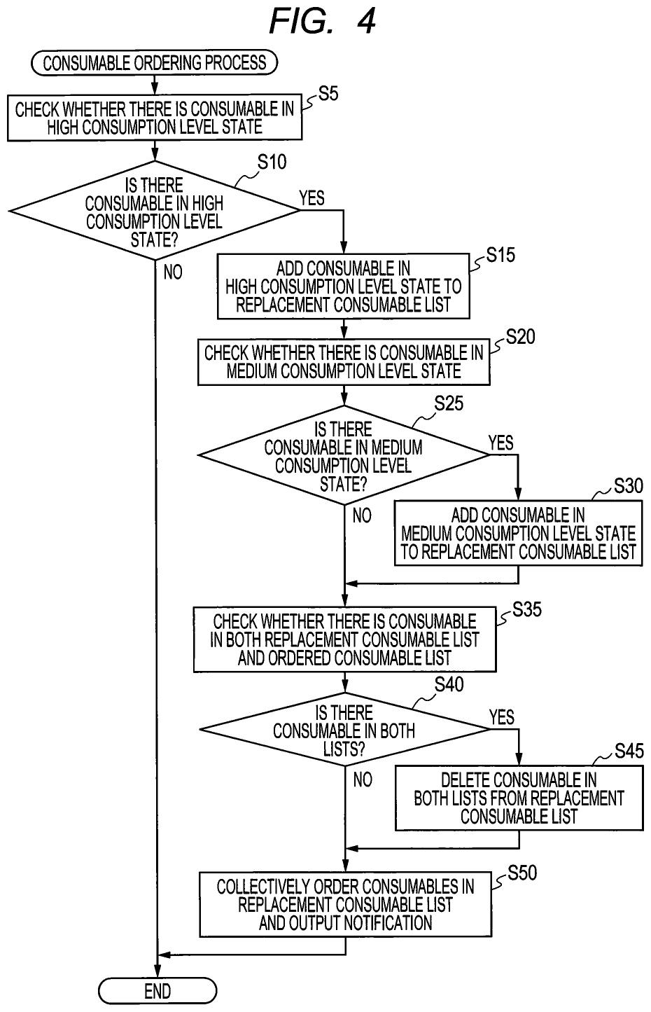

FIG. 4 is a flowchart showing a detailed procedure of a consumable ordering process in a multifunction peripheral.

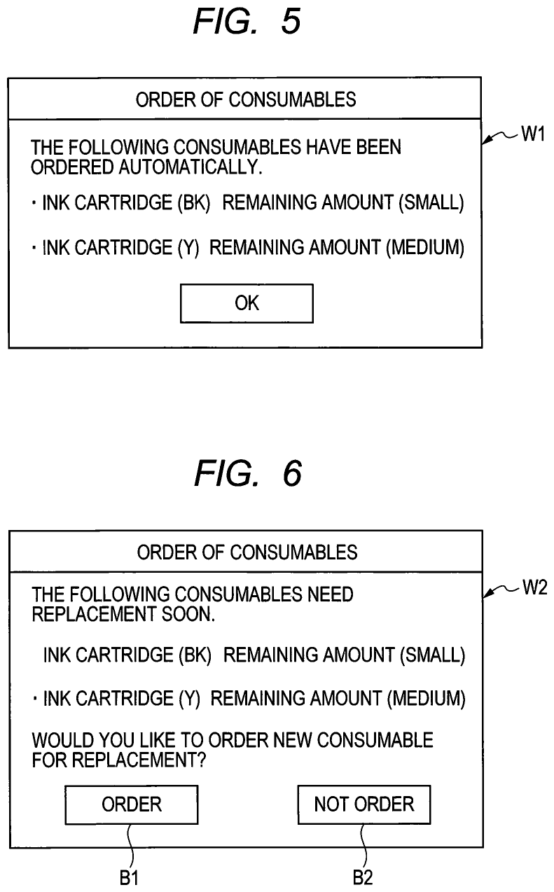

FIG. 5 is a diagram showing an example of a message window regarding automatic ordering of consumables.

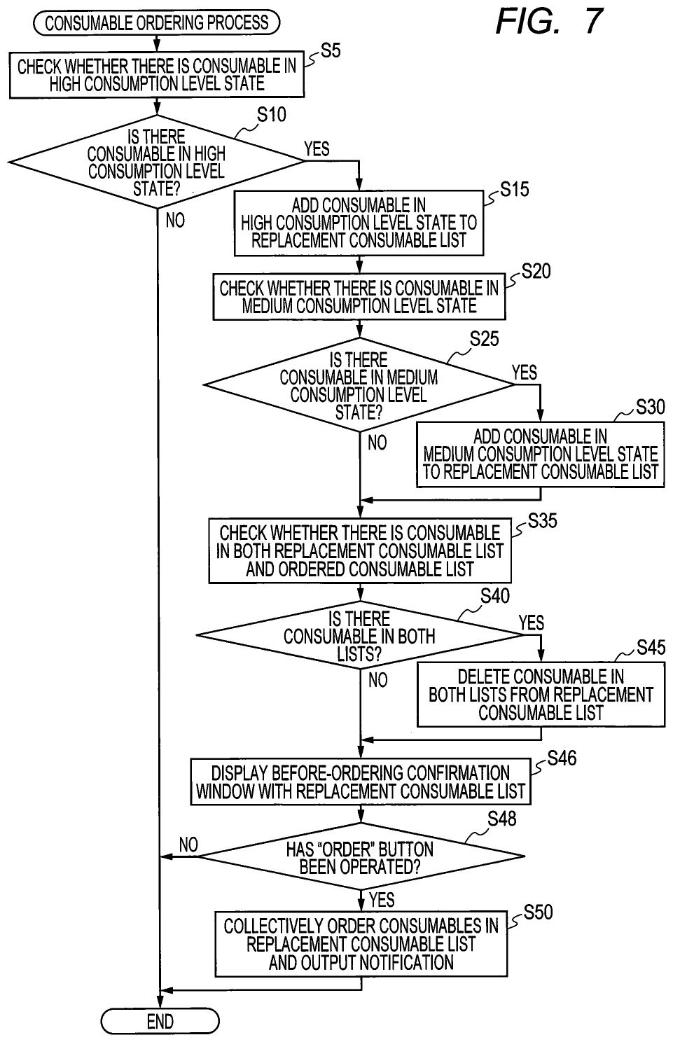

FIG. 6 is a diagram showing an example of a message window for performing a before-ordering confirmation display.

FIG. 7 is a flowchart showing a detailed procedure of a consumable ordering process in a multifunction peripheral when a before-ordering confirmation display is displayed.

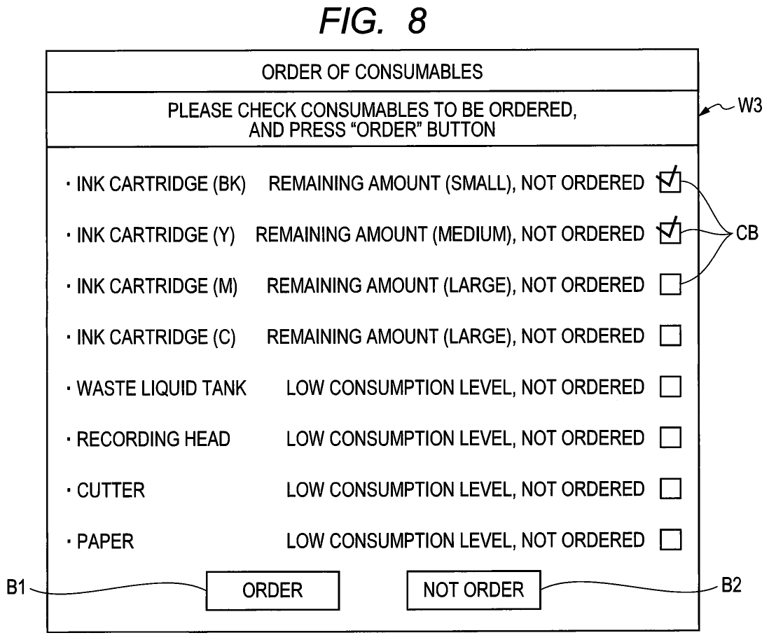

FIG. 8 is a diagram showing an example of a message window for performing a before-ordering confirmation display for all consumables.

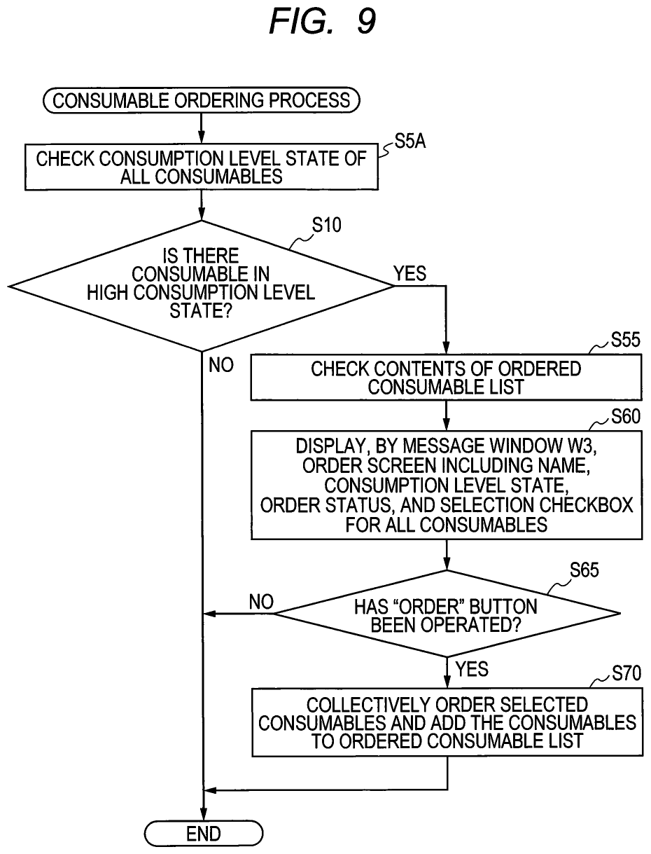

FIG. 9 is a flowchart showing a detailed procedure of a consumable ordering process in a multifunction peripheral in a case where all consumables are displayed in a before-ordering confirmation display.

FIG. 1 shows a print processing system according to an embodiment. This embodiment relates to a print processing system 1 configured to provide a delivery service based on an ordering contract for automatically ordering replacement consumables when consumables used in a multifunction peripheral 200 have been consumed to a certain degree.

<Overview of Print Processing System>

In FIG. 1, the print processing system 1 includes an information management server 100, the multifunction peripheral (MFP) 200, a mobile terminal 300, and a delivery management server 400. The information management server 100, the MFP 200, the mobile terminal 300, and the delivery management server 400 are connected to a network NT and communicate with one another. The MFP 200 is an example of an image recording apparatus.

<Information Management Server>

The information management server 100 is installed and managed by the manufacturer of the MFP 200, for example. The information management server 100 includes a processor 110, a memory 115, and an interface 190. The processor 110, the memory 115, and the interface 190 are connected to one another via a bus 105.

The memory 115 includes a volatile memory 120 and a non-volatile memory 130. The volatile memory 120 is, for example, a DRAM, and temporarily stores various data. The non-volatile memory 130 is, for example, a hard disk drive or solid state drive, and includes a program storage area 131 and a data storage area (not shown).

The processor 110 is a device that performs data processing, such as a CPU. By executing programs stored in the program storage area 131, the processor 110 executes various processes including data communication with the mobile terminal 300, the MFP 200, and the delivery management server 400 connected to the network NT.

The interface 190 is a wired LAN interface or a wireless interface for communicating with other devices, and is connected to the network NT.

<Delivery Management Server>

The delivery management server 400 is installed, for example, in a company that provides delivery services for various goods. The delivery management server 400 includes a processor, a memory, and an interface for connecting to the network NT (not shown).

<Multifunction Peripheral (MFP)>

The MFP 200 is owned by, for example, a company that provides a printing service. The MFP 200 may be owned by the user who uses the same. The MFP 200 includes an interface 270, a processor 210, a print engine 290, a consumption detection sensor 285, a scanner unit 280, a cartridge holder 51, an ink remaining-amount sensor 52, a memory 215, a display 240, and an operation interface 250. The interface 270, the processor 210, the print engine 290, the consumption detection sensor 285, the scanner unit 280, the ink remaining-amount sensor 52, the memory 215, the display 240, and the operation interface 250 are connected to one another via a bus 205.

The memory 215 includes a volatile memory 220 and a non-volatile memory 230. The volatile memory 220 is, for example, a DRAM, and temporarily stores various data. The non-volatile memory 230 is, for example, a flash memory. The non-volatile memory 230 includes a replacement consumable list 231, an ordered consumable list 232, and a program storage area 233. Various programs are stored in the program storage area 233, and the various programs include a consumable order processing program of this embodiment related to execution of flowcharts such as FIGS. 4 and 7 described later. The consumable order processing program is preliminarily stored in the program storage area 233 as firmware, for example. The non-volatile memory 230 also stores a consumption level determination table (not shown). The consumption level determination table, the replacement consumable list 231, and the ordered consumable list 232 will be described later.

The processor 210 is a device that performs various processes, such as a CPU. The processor 210 is an example of a controller. The processor 210 executes the above-mentioned consumable order processing program stored in the program storage area 233.

The display 240 is, for example, a liquid crystal display. The operation interface 250 is a device that receives an operation by the user. The user inputs various instructions to the MFP 200 by operating the operation interface 250. The communication interface 270 is a wired or wireless network interface for communicating with other devices, and is connected to the network NT.

The scanner unit 280 generates scan data representing read image by optically reading a document, which is an object to be read, by using a photoelectric conversion element such as a CCD or a CMOS.

The print engine 290 prints an image on a conveyed sheet by a particular method while taking out and conveying a sheet in a sheet feed tray by a conveyance mechanism (not shown). A case where printing is performed by an inkjet method will be described below as an example. That is, the print engine 290 forms an image on a sheet by using the ink in ink cartridges 50 that are detachably attached to the cartridge holder 51. The sheet is an example of a recording medium. Specifically, the ink cartridges 50 include ink cartridges of yellow ink (Y), magenta ink (M), cyan ink (C), and black ink (BK), but unless otherwise specified, they will be described simply as “ink cartridge 50” without distinguishing between the ink cartridges 50 of these colors. The ink remaining-amount sensor 52 is a sensor that individually detects a remaining amount of ink in each of the plurality of ink cartridges 50, which are consumables.

The components of the print engine 290 include consumables that need to be replaced due to consumption, wear, and aging due to repeated image printing, as in the case of the ink cartridges 50. In the case of the inkjet print engine 290 of this example, for example, a waste liquid tank that stores used ink, a recording head that is an ink head that ejects ink onto a sheet during printing, a cutter that cuts a sheet, and so on (not shown). The sheet itself is also a kind of consumables. The consumption detection sensor 285 in this embodiment is an assembly of sensors for individually detecting consumption states of various consumables for the print engine 290. The print engine 290 is an example of an image recording unit.

<Mobile Terminal>

The mobile terminal 300 is a mobile terminal such as a smartphone owned by the user, and is connected to the network NT via wireless communication. The mobile terminal 300 includes a processor, a memory, and an interface for connecting to the network NT (not shown). Various programs are stored in a program storage area provided in the memory. Instead of the mobile terminal 300, another information terminal such as a personal computer and a tablet computer may be used.

<Consumable Ordering Process by MFP>

In this embodiment, the print processing system 1 having the configuration described above allows the execution of the processing of automatically ordering a consumable for replacement which is included in the MFP 200 described above, when the consumable is consumed and needs to be replaced.

In the MFP 200, the ink remaining-amount sensor 52 and the consumption detection sensor 285 described above sequentially detect and monitor the consumption levels (the degrees of consumption) of the respective consumables of the ink cartridges 50 for respective colors, the waste liquid tank, the recording head, the cutter, and the sheet in this example. In this case, the necessity of replacement of each consumable is determined based on the consumption level determination table as shown in FIG. 2. In the example shown in FIG. 2, the consumption level determination table indicates a name of a consumable and an index of the consumption level divided into three levels that correspond to each of identification numbers (No. 1 to No. 7 in the example shown in the figure) relating to all of the consumables.

The index of the consumption level is obtained by first dividing, by using the detection values (signal values) of each of the ink remaining-amount sensor 52 and the consumption detection sensor 285, the range of the sensor detection values between the state of a new consumable immediate after replacement and the state of the consumable consumed to its limit according to specifications into ten equal parts, for normalization. Each of the ten equal parts is treated as a unit, and the index of the consumption level is indicated by three levels: a low consumption level state in which a consumable is regarded in the state close to a new consumable; a high consumption level state in which a consumable is regarded to need replacement; and a medium consumption level state in which a consumable is regarded in the state therebetween. The pace of consumption of consumables differs greatly depending on the types of consumables, and accordingly the ten equal unit parts corresponding to the three levels of the consumption levels are greatly different. In other words, a consumable which is consumed at a fast pace, for example, the ink cartridges 50 is set as the high consumption level state requiring replacement even when the consumable is in a relatively low consumption state. A consumable which is consumed at a slow pace, for example, the recording head, is set as the medium consumption level state until the consumable becomes a relatively high consumption state. Specifically, based on sensor detection values for each type of consumable, a low-medium threshold corresponding to the boundary between the low consumption level and the medium consumption level, and a medium-high threshold corresponding to the boundary between the medium consumption level and the high consumption level are recorded in advance. And, the level of the consumption level is determined by comparing the sensor detection value actually detected with each threshold.

As described above, if the consumption levels of the consumables included in the MFP 200 are determined and some of the consumables are determined to need replacement, automatic ordering of consumables for replacement is convenient for the user. However, the MFP 200 includes a large number of consumables. If a consumable for replacement is ordered every time a consumable is determined to need replacement, the consumables are delivered to the user one after another. Accordingly, the reception and management of the consumables requires much time and effort of the user, and imposes a burden on the user.

The MFP 200 in this embodiment performs an order process of concurrently ordering a plurality of consumables which are in the consumption levels close to some extent when the consumables are consumed and need to be ordered for replacement. As shown in FIGS. 3A and 3B, only ink cartridges 1 and 2 are considered for ease of understanding. As shown in FIG. 3A, when one ink cartridge 1 reaches the high consumption level state and the other ink cartridge 2 is still in the low consumption level state, only the ink cartridge 1 is ordered. As shown in FIG. 3B, when one ink cartridge 1 reaches the high consumption level state and the other ink cartridge 2 is in the medium consumption level state, both of the ink cartridges 1 and 2 are ordered.

As described above, when one consumable is consumed greatly and the other consumable is also consumed to some extent at the time of ordering the one consumable, even when the consumption levels of the two consumables are not identical to each other, the other consumable is also ordered concurrently. The order process above allows the concurrent ordering and delivery of the plurality of consumables whose consumption levels are advanced and relatively similar to each other, with less burden on the user compared to the case where the consumables are delivered at separate timings.

When a consumable for replacement is ordered at an earlier timing and delivered even when the consumable is still in the low consumption level state corresponding to the state close to a new consumable, the user has to manage the consumable for replacement for a long time until it is actually replaced, and the management operation imposes a burden on the user. Thus, the above-described low-medium threshold corresponding to the boundary between the low consumption level and the medium consumption level also needs to be appropriately set by taking into consideration the paces of consumption of the consumables.

In this embodiment, the consumables determined to need replacement and the consumables having already been ordered are separately managed in order to prevent double ordering of the consumables having already been ordered. Specifically, the consumables in the high consumption level state determined to need ordering immediately based on the sensor detection value most recently detected and the consumables in the medium consumption level state determined to need ordering concurrently are all recorded in the replacement consumable list 231. Based on an order history and a replacement history, the consumable which has already been ordered but is not yet replaced at that point is recorded in the ordered consumable list 232. Among the consumables recorded in the replacement consumable list 231, the consumable recorded also in the ordered consumable list 232 is determined to have already been ordered, and is deleted from the replacement consumable list 231. Then, only the consumable remaining in the replacement consumable list 231 is actually ordered, so that double ordering is prevented. The ordering method is particularly useful when it requires considerable time from actual ordering of a consumable to the timing when the consumable is delivered to the user and becomes ready for replacement.

The ink cartridge 1 in the above example is an example of a first consumable, and the ink cartridge 2 is an example of a second consumable. The low consumption level state, the medium consumption level state, and the high consumption level state of the ink cartridge 1 are examples of a first state, a second state, and a third state, respectively. The low consumption level state, the medium consumption level state, and the high consumption level state of the ink cartridge 2 are examples of a fourth state, a fifth state, and a sixth state, respectively. The range of sensor detection values from a new state to a maximum consumption state of each of the ink cartridges 1 and 2 is an example of an expected life, and the corresponding sensor detection values are examples of a first consumption state amount and a second consumption state amount. The medium-high threshold of the ink cartridge 1 is an example of a first threshold, and the medium-high threshold of the ink cartridge 2 is an example of a second threshold.

<Control Procedure>

FIG. 4 illustrates a flowchart of one example of control procedure in a consumable ordering process to be executed by the processor 210 of the MFP 200, which realizes the method described above in this embodiment. The following procedure is started after the MFP 200 executes an operation of consuming consumables such as printing or periodic maintenance of the recording head.

In S5, the processor 210 checks whether there is a consumable in the high consumption level state, which needs to be replaced, among all of the consumables included in the MFP 200. Specifically, the processor 210 determines the level of the consumption level state of each consumable by comparing the detection value detected by the corresponding detection sensor with the consumption level determination table described above, and checks which consumable among them is in the high consumption level state.

In S10, the processor 210 determines whether there is at least one consumable in the high consumption level state. When there is no consumable in the high consumption level state, a negative (NO) determination is made, and the processing ends. When there is at least one consumable in the high consumption level state, a positive (YES) determination is made, and the processing moves to S15.

In S15, the processor 210 adds the consumable in the high consumption level state to the replacement consumable list 231. In S20, the processor 210 checks whether there is a consumable in the medium consumption level state. The specific method of confirming the consumption level is the same as S5 described above. In S25, the processor 210 determines whether there is at least one consumable in the medium consumption level state. When there is no consumable in the medium consumption level state, a negative (NO) determination is made, and the processing moves to S35. When there is at least one consumable in the medium consumption level state, a positive (YES) determination is made, and the processing moves to S30. In S30, the processor 210 adds the consumable in the medium consumption level state to the replacement consumable list 231, and the processing moves to S35.

In S35, the processor 210 checks whether, among consumables recorded in the replacement consumable list 231 at that point, there is a consumable recorded redundantly (overlappingly) in the ordered consumable list 232. In S40, the processor 210 determines whether there is at least one consumable redundantly recorded. When there is no consumable redundantly recorded, a negative (NO) determination is made, and the processing moves to S50. When there is at least one consumable redundantly recorded, a positive (YES) determination is made, and the processing moves to S45. In S45, the processor 210 deletes the consumable redundantly recorded from the replacement consumable list 231, and the processing moves to S50. In a case where the consumables in the high consumption level state are deleted from the replacement consumable list 231 in S45 and resultantly only the consumables in the medium consumption level state remain in the replacement consumable list 231, the processor 210 also deletes the consumables in the medium consumption level state from the replacement consumable list 231.

In S50, the processor 210 collectively orders all of the consumables recorded in the replacement consumable list 231 at that point. Specifically, the processor 210 transmits the names of the consumables recorded in the replacement consumable list 231 and a request command of ordering these to the information management server 100 so that the order process is executed in cooperation with the delivery management server 400. The MFP 200 in the example of this embodiment notifies the user, at that point, about the execution of automatic ordering of the consumables and the ordered contents, by displaying, for example, a message window W1 as shown in FIG. 5 on the display 240. The message window W1 in the illustrated example indicates that the yellow (Y) ink cartridge having a medium remaining amount of ink, that is, in the medium consumption level state has been concurrently ordered, which is triggered by detection that the black (BK) ink cartridge reaches a small remaining amount of ink, that is, the high consumption level state. For example, when the yellow ink cartridge has already been ordered and is recorded in the ordered consumable list 232 at this point, only the black ink cartridge is ordered and a notification is made. When the black ink cartridge has already been ordered or the both have already been ordered, neither the ordering nor the notification at that point is not executed. After the completion of the processing of ordering the consumables recorded in the replacement consumable list 231, the processor 210 adds the names of the ordered consumables to the ordered consumable list 232, and deletes all of the contents in the replacement consumable list 231 (not shown). Thereafter, the processing ends.

In the above, the step S5 is an example of a first determination process and a second determination process. The steps S15 to S50 are an example of an order selection process. The step in the case of a negative (NO) determination in S25 is a first process. The step S30 in the case of a positive (YES) determination in S25 is an example of a second process.

### Effects of Embodiment

As described above, in this embodiment, when consumables are consumed and need to be ordered for replacement, the plurality of consumables whose consumption levels are close to some extent are ordered at the same timing. The processor 210 of the MFP 200 executes the processing of S5.

In S5, in the example described above, based on the three states set by dividing the consumption range of the ink cartridge 1, the processor 210 determines which consumption level state the ink cartridge 1 corresponds to among the low consumption level state, the medium consumption level state, and the high consumption level state. Further, in S5, in the example described above, based on the three states set by dividing the consumption range of the ink cartridge 2 different from the ink cartridge 1, the processor 210 determines which consumption level state the ink cartridge 2 corresponds to among the low consumption level state, the medium consumption level state, and the high consumption level state.

Each of the ink cartridges 1, 2 transitions in the order of the low consumption level state, the medium consumption level state, and the high consumption level state, as they are consumed. When the ink cartridge 1 is consumed more and earlier than the ink cartridge 2, and the ink cartridge 1 transitions to the high consumption level state earlier than the ink cartridge 2, the processor 210 executes the processing from S15 to S50.

In the processing from S15 to S50, an order process or a non-order process is selectively executed for the ink cartridge 1 and the ink cartridge 2. In a case where the ink cartridge 2 is still in the low consumption level state at the time when the ink cartridge 1 becomes the high consumption level state requiring replacement, a negative (NO) determination is made in S25, and the processor 210 executes the order process for only the ink cartridge 1, and executes the non-order process for the ink cartridge 2. When the ink cartridge 2 is in the medium consumption level state at the time when the ink cartridge 1 becomes the high consumption level state, a positive (YES) determination is made in S25, and the processor 210 in S30 executes the order process for the ink cartridge 1, and also executes the order process for the ink cartridge 2.

In this embodiment, when the ink cartridge 2 is consumed to some extent at the time when the order process for the ink cartridge 1 greatly consumed is to be executed, even when the consumption levels of the ink cartridge 1 and the ink cartridge 2 are not identical to each other, the order process for the ink cartridge 2 is also executed concurrently. Since the ink cartridge 1 and the ink cartridge 2 are concurrently ordered and delivered, the burden on the user is reduced compared to the case where the ink cartridge 2 is delivered at another timing after the ink cartridge 1 is delivered.

The effect described above is obtained not only in the case of the same type of consumables such as the two ink cartridges 1, 2 in the example above, but also in the case of different types of consumables. The effect is obtained not only in the case of two consumables, but also in the case of three or more consumables.

In this embodiment, if the ink cartridge 2 has already been ordered when the ink cartridge 1 becomes the high consumption level state and the ink cartridge 2 is in the medium consumption level state at that time, a negative (NO) determination is made in S25, and the processor 210 executes the non-order process for the ink cartridge 2, and the ink cartridge 2 is not ordered. In this embodiment, it is prevented that the ink cartridge 2 is ordered repetitively.

In this embodiment, if the ink cartridge 1 has already been ordered at the time when the ink cartridge 1 becomes the high consumption level state, the ink cartridge 1 is not ordered. Since the ink cartridge 1 and the ink cartridge 2 are not ordered concurrently, the ink cartridge 2 even in the medium consumption level state is not ordered. In this embodiment, it is prevented that only the ink cartridge 2 having not yet reached the high consumption level state is ordered.

In this embodiment, with respect to the sensor detection value (remaining amount of ink) representing the consumption level of the ink cartridge 1, the medium-high threshold is set corresponding to the boundary between the medium consumption level state and the high consumption level state. With respect to the sensor detection value (remaining amount of ink) representing the consumption level of the ink cartridge 2, the medium-high threshold is set corresponding to the boundary between the medium consumption level state and the high consumption level state. In this embodiment, it is accurately determined that the ink cartridge 1 has transitioned from the medium consumption level state to the high consumption level state, based on that the sensor detection value of the ink cartridge 1 has reached the corresponding medium-high threshold. It is also accurately determined that the ink cartridge 2 has transitioned from the medium consumption level state to the high consumption level state, based on that the sensor detection value of the ink cartridge 2 has reached the corresponding medium-high threshold.

In this embodiment, the consumption level states are determined based on the sensor detection value representing the consumption level of the ink cartridge 1 and the sensor detection value representing the consumption level of the ink cartridge 2, but the method is not limited thereto. For example, the consumption level of ink may be estimated by counting use data such as the number of printed sheets or the number of times of recording by the recording head. For example, the consumption level state of a cutter may be estimated by using the number of times of cutting as an index. With these methods, the consumption level state may be determined even without any sensor for detecting the consumption level state.

The control indicated in the flowchart of FIG. 4 may be executed at a timing other than the timing of the operation of consuming a consumable. For example, the control may be executed at the timing when power is turned on, or the timing when connection to the network NT is made, and may be executed at an appropriate timing to prompt the user to order a consumable.

The control indicated in the flowchart of FIG. 4 may be executed periodically, for example, hourly or daily. In this case, the notification in S50 may be displayed when the user performs an operation.

In this embodiment, the MFP 200 includes, as consumables, at least one of an ink cartridge, a waste liquid tank for storing used ink, a recording head, a cutter for cutting a recording medium, and a recording medium. In this embodiment, the MFP 200 in the case of a so-called inkjet printer allows the concurrent delivery of a plurality of corresponding consumables, and the burden on the user is thus reduced. The MFP 200 in the case of a laser printer includes, as consumables, at least one of a toner cartridge, a waste toner box for storing used toner, a development cartridge, a process cartridge, a drum unit, a belt unit, and a recording medium. The MFP 200 in the case of a so-called laser printer as described above allows the concurrent delivery of a plurality of corresponding consumables, and the burden on the user is thus reduced.

In the above embodiment, the processor 210 of the MFP 200 executes an automatic order process according to the consumption level state of the consumables in the MFP 200, but this disclosure is not limited to this. For example, the information management server 100 may store the replacement consumable list 231 and the ordered consumable list 232 individually corresponding to each of a plurality of MFPs 200 in the non-volatile memory 130, and the processor 110 may receive information on the consumption level state of each consumable from each MFP 200 and execute the automatic order process. In this case, the information management server 100 is an example of an external apparatus, the processor 110 is an example of a controller, and the information on the consumption level state of each consumable is an example of first information and second information. The steps of acquiring the first information and the second information are examples of a first acquisition step and a second acquisition step. The step of selectively performing an order process and a non-order process for which consumables is an example of an order selection step. The step of ordering only a consumable in the high consumption level state is an example of a first step. The step of ordering both a consumable in the high consumption level state and a consumable in the medium consumption level state is an example of a second step. The information on which of the low consumption level state and the medium consumption level state the consumption level of the consumable corresponds to is an example of third information. Further, the mobile terminal 300, an operation terminal configured by a general-purpose personal computer (not shown), and so on may execute the automatic order process instead of the MFP 200.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below.

(1) Case where Before-Ordering Confirmation Display is Executed

In the embodiment described above, the user is notified about the execution and the contents of the order process of consumables by displaying the message window W1 (refer to FIG. 5 described above) after the completion of the ordering of all of the consumables recorded in the replacement consumable list 231, but the method is not limited thereto. For example, as in a message window W2 shown in FIG. 6, before the actual execution of the order process, the detection of a particular consumable in the high consumption level state (“ink cartridge BK” in the illustrated example) and the necessity of corresponding ordering are indicated so as to prompt the user to finally select whether to order the consumable. At this time, when another consumable in the medium consumption level state (“ink cartridge Y” in the illustrated example) is recorded in the replacement consumable list 231, the consumable is also displayed in the message window W2. As with the embodiment described above, the consumables having already been ordered are deleted from the replacement consumable list 231, and are not displayed in the message window W2. The names of the consumables displayed in the message window W2 are just examples of identification information, and a button B1 indicating “ORDER” and a button B2 indicating “NOT ORDER” are examples of determination operation objects.

In this case, as shown in the flowchart of FIG. 7, after the consumable recorded in both of the replacement consumable list 231 and the ordered consumable list 232 is deleted, that is, after S40 and S45, before-ordering confirmation display is executed in S46. Specifically, the names and the consumption level states of the consumables recorded in the replacement consumable list 231 are displayed in the message window W2 as shown in FIG. 6 described above so as to prompt the user to press the button B1 indicating “ORDER” or the button B2 indicating “NOT ORDER”. Pressing the button B2 indicating “NOT ORDER” means that a negative (NO) determination is made in S48, and the processing ends. Pressing the button B1 indicating “ORDER” means that a positive (YES) determination is made in S48, and the processing moves to S50 in which the order process is executed.

In the above, the display 240 is an example of a display. The message window W2 is an example of an order screen. The steps of S15 to S50 are an example of a first display selection process. The step of S46 in the case of a negative (NO) determination in S25 is an example of a third process. The steps of S30 and S46 in the case of a positive (YES) determination in S25 is an example of a fourth process.

As described above, in this modification, when the ink cartridge 2 is consumed to some extent at the time when the ink cartridge 1 is greatly consumed, even when the consumption levels of the ink cartridge 1 and the ink cartridge 2 in the example described above are not identical to each other, the message window W2 also including the ink cartridge 2 is displayed on the display 240. Since the message window W2 indicates both of the ink cartridge 1 and the ink cartridge 2, the ink cartridge 1 and the ink cartridge 2 are ordered and delivered concurrently. As a result, the burden on the user is reduced compared to the case where the ink cartridge 2 is delivered at another timing after the ink cartridge 1 is delivered. Alternatively, a pressing operation of the button B1 indicating “ORDER” or the button B2 indicating “NOT ORDER” may be omitted, and a notification of the automatic order process may be simply given to the user in advance. Further alternatively, the user may perform the order process by another appropriate operation.

In this modification, if the ink cartridge 2 has already been ordered when the ink cartridge 1 becomes the high consumption level state and the ink cartridge 2 is in the medium consumption level state at that time, the message window W2 is not displayed. In this modification, in S46 after a negative (NO) determination is made in S25, the information of the ordered ink cartridge 2 is not displayed, so that it is prevented that the ink cartridge 2 is ordered redundantly and repetitively.

In this modification, if the ink cartridge 1 has already been ordered at the time when the ink cartridge 1 becomes the high consumption level state, the information of the ink cartridge 1 is not displayed in the message window W2. Since the ink cartridge 1 and the ink cartridge 2 are not ordered concurrently, the information of the ink cartridge 2 is not displayed in the message window W2. In this modification, it is prevented that only the ink cartridge 2 having not yet reached the high consumption level state is displayed. In this case, since there is nothing to be ordered, the message window W2 itself is not displayed.

In this modification, the button B1 indicating “ORDER” and the button B2 indicating “NOT ORDER” are displayed in the message window W2 by the control of the processor 210. In this modification, an operator determines whether to order consumables collectively, after checking the names of the consumables displayed in the message window W2.

In this modification, the button B1 indicating “ORDER” and the button B2 indicating “NOT ORDER” may be provided for each consumable in the message window W2, so as to allow the user to determine whether to order each consumable individually. For example, the user may obtain a consumable by another method (for example, purchase at store), without using the ordering system described above. The user may already have a consumable which is not recognized by a printer. By providing individual ordering means for the user, the user selectively determines whether collective ordering or individual ordering of consumables is executed, and thus improves convenience.

(2) Case where all Consumables are Displayed in Before-Ordering Confirmation Display

In the first modification described above, the message window W2 for the before-ordering confirmation display indicates only the consumables in the high consumption level state and the medium consumption level state, but the display is not limited thereto. For example, as in a message window W3 shown in FIG. 8, when one consumable becomes the high consumption level state, the names of all of the consumables included in the MFP 200, their respective consumption level states, and their ordering statuses are displayed in a list, so as to allow the user to select and order some consumables from the list.

The message window W3 indicates a display mode of the case where the “Ink cartridge BK” has “Small remaining amount” corresponding to the high consumption level state. The message window W3 indicates a check box CB for each consumable so as to allow the user to selectively determine whether to order each consumable by checking or unchecking the corresponding check box CB. The check boxes CB for the consumables in the high consumption level state and the medium consumption level state are displayed with check marks indicating a selected state in default setting, and the check boxes CB for the consumables of the low consumption level state are displayed with no check mark indicating a non-selected state in default setting.

The user arbitrarily may change any check box CB for a consumable from a corresponding default display state, and orders all of the consumables corresponding to the check boxes CB displayed with check marks when finally pressing the button B1 indicating “ORDER”. When the button B2 indicating “NOT ORDER” is finally pressed, the processing ends without ordering any consumable, regardless of the status of the check boxes CB.

In this modification, the processor 210 of the MFP 200 executes a consumable ordering process shown in the flowchart of FIG. 9. First, in S5A, the processor 210 checks the consumption level states at that point of all of the consumables included in the MFP 200.

In S10, the processor 210 determines whether there is at least one consumable in the high consumption level state. When there is no consumable in the high consumption level state, a negative (NO) determination is made, and the processing ends. When there is at least one consumable in the high consumption level state, a positive (YES) determination is made, and the processing moves to S55.

In S55, the processor 210 checks the ordering status indicating which consumables have been ordered, by referring to the records in the ordered consumable list 232 at that point. Then in S60, the processor 210 displays, on the display 240, the message window W3 indicating the list of the respective names, the consumption level states, the ordering statuses, and the check boxes CB for selection in the default display modes corresponding to the consumption level states, with respect to all of the consumables, so as to receive the user's operation.

Pressing the button B2 indicating “NOT ORDER” means that a negative (NO) determination is made in S65, and the processing ends. Pressing the button B1 indicating “ORDER” means that a positive (YES) determination is made in S65, and the processing moves to S70 in which the processor 210 orders the selected consumables collectively and records their names in the ordered consumable list. The processing then ends.

The step of S5A is an example of a third determination process. The check box CB is an example of a selection operation portion. The steps of S55 to S70 are an example of a second display selection process. The step of S60 is an example of a fifth process and a sixth process. The display contents of “ink cartridge (BK)” and “remaining amount (small)” are examples of a first object. The display contents of “ink cartridge (Y)” and “remaining amount (medium)” are examples of a second object. The display content indicating whether an order has already been placed is an example of a third object.

As described above, in this modification, when the ink cartridge 1 is greatly consumed, even when the consumption levels of the ink cartridge 1 and the ink cartridge 2 are not identical to each other, the processor 210 executes a display process of displaying that the ink cartridge 1 is in the high consumption level state, and a display process of displaying that the ink cartridge 2 is in the medium consumption level state. This allows the ink cartridge 1 and the ink cartridge 2 to be ordered and delivered concurrently, and the burden on the user is thus reduced compared to the case where the ink cartridge 2 is delivered at another timing after the ink cartridge 1 is delivered.

In this modification, the check boxes CB corresponding to the respective consumables are displayed in the message window W3 by the control of the processor 210. In this modification, the operator determines whether to include, as the target of collective ordering, each consumable whose name is displayed in the message window W3.

In this modification, in a case where one consumable becomes the high consumption level state (thus displayed in the message window W3) and some other consumables are in the low consumption level state, the other consumables have less necessity for ordering at that point due to their lower consumption levels. In this case, the message window W3 displays the check boxes CB for the consumables of the low consumption level states, as not being selected for ordering (the states with no check mark), in default setting.

When some other consumables than the consumable in the high consumption level state are in the medium consumption level state, the other consumables are consumed to some extent unlike the case described above, and have higher possibility of being ordered at that point. In this case, the check boxes CB are displayed on the order screen, as being selected for ordering (the state with check marks) in default setting.

In this modification, the default screen mode is appropriately provided according to the indicated status of the consumption level states of the ink cartridge 1 and the ink cartridge 2, which improves convenience for the operator.

In this modification, the ordering statuses of all of the consumables are displayed in the message window W3 by the control of the processor 210. In this modification, the operator recognizes whether each consumable whose name is displayed in the message window W3 has already been ordered. In addition, the operator may additionally order a consumable that has already been ordered.

There are some combinations of types of consumables which can be concurrently delivered from a distribution center, and other combinations which cannot be concurrently delivered. To deal with the situation, the message window W3 may display the name and the consumption level state of the ink cartridge 2 when the ink cartridge 2 can be concurrently delivered with the ink cartridge 1, and may not display the name or the consumption level state of the ink cartridge 2 when the ink cartridge 2 cannot be concurrently delivered with the ink cartridge 1 (not shown).

According to this method, in a case where the ink cartridge 2 cannot be concurrently delivered with the ink cartridge 1, even when the name and the consumption level state of the ink cartridge 1 are displayed, the name and the consumption level state of the ink cartridge 2 are not displayed. This prevents concurrent ordering of the ink cartridge 1 and the ink cartridge 2 in a case where the ink cartridge 1 and the ink cartridge 2 cannot be concurrently delivered due to a physical factor, for example, circumstances of a delivery trader.

As another method in the modification described above, the consumables which can be concurrently delivered may be displayed in the upper and lower rows, collectively, and it may be indicated that the consumables will be delivered separately. The method allows the operator to easily collectively select and order only the consumables which can be concurrently delivered.

This disclosure is not limited to the steps shown in the flows shown in FIGS. 4, 7, and so on, and steps may be added, deleted, or the order of steps may be changed.

In addition to the methods already described above, the methods according to the above embodiments and modifications may be appropriately combined and used.

What is claimed is:

1. An image recording apparatus comprising:
a print engine configured to record an image on a recording medium;
at least two consumables including a first consumable and a second consumable; and
a controller configured to perform:
determining which of a first state, a second state, and a third state a consumption level of the first consumable corresponds to, a consumption level of the second state being higher than the consumption level of the first state, a consumption level of the third state being higher than the consumption level of the second state;
determining which of a fourth state, a fifth state, and a sixth state a consumption level of the second consumable corresponds to, a consumption level of the fifth state being higher than the consumption level of the fourth state, a consumption level of the sixth state being higher than the consumption level of the fifth state; and
in a case where the first consumable becomes the third state before the second consumable becomes the sixth state, selectively performing an order process or a non-order process for the first consumable and the second consumable based on determination results of the consumption level of the first consumable and the consumption level of the second consumable,
the selectively performing the order process or the non-order process including:
in a case where the second consumable is in the fourth state, performing the order process for the first consumable and performing the non-order process for the second consumable; and
in a case where the second consumable is in the fifth state, performing the order process for the first consumable and performing the order process for the second consumable.

2. The image recording apparatus according to claim 1, wherein the selectively performing the order process or the non-order process includes:
in a case where the second consumable is in the fourth state or the second consumable is already ordered, performing the order process for the first consumable and performing the non-order process for the second consumable; and
in a case where the second consumable is in the fifth state and the second consumable is not ordered yet, performing the order process for the first consumable and performing the order process for the second consumable.

3. The image recording apparatus according to claim 1, wherein the selectively performing the order process or the non-order process includes:
in a case where the first consumable is already ordered, performing the non-order process for the first consumable and the second consumable.

4. The image recording apparatus according to claim 1, wherein a first threshold of a first consumption state amount is set as a threshold corresponding to a boundary between the second state and the third state, the first consumption state amount indicating the consumption level of the first consumable relative to an expected life of the first consumable;
wherein a second threshold of a second consumption state amount is set as a threshold corresponding to a boundary between the fifth state and the sixth state, the second consumption state amount indicating the consumption level of the second consumable relative to an expected life of the second consumable; and
wherein the controller is configured to:
in a case where the first consumption state amount of the first consumable reaches the first threshold, determine that the consumption level of the first consumable changes from the second state to the third state; and
in a case where the second consumption state amount of the second consumable reaches the second threshold, determine that the consumption level of the second consumable changes from the fifth state to the sixth state.

5. The image recording apparatus according to claim 1, wherein each of the at least two consumables is an ink cartridge, a waste liquid tank configured to store used ink, a recording head, a cutter configured to cut a recording medium, or a recording medium.

6. The image recording apparatus according to claim 1, wherein each of the at least two consumables is a toner cartridge, a waste toner box configured to store used toner, a development cartridge, a process cartridge, a drum unit, a belt unit, or a recording medium.

7. An image recording apparatus comprising:
a print engine configured to record an image on a recording medium;
at least two consumables including a first consumable and a second consumable;
a display; and
a controller configured to perform:
determining which of a first state, a second state, and a third state a consumption level of the first consumable corresponds to, a consumption level of the second state being higher than the consumption level of the first state, a consumption level of the third state being higher than the consumption level of the second state;
determining which of a fourth state, a fifth state, and a sixth state a consumption level of the second consumable corresponds to, a consumption level of the fifth state being higher than the consumption level of the fourth state, a consumption level of the sixth state being higher than the consumption level of the fifth state; and
in a case where the first consumable becomes the third state before the second consumable becomes the sixth state, selectively performing a display process or a non-display process in an order screen of the display for the first consumable and the second consumable based on determination results of the consumption level of the first consumable and the consumption level of the second consumable,
the selectively performing the display process or the non-display process including:
in a case where the second consumable is in the fourth state, performing the display process for the first consumable and performing the non-display process for the second consumable; and
in a case where the second consumable is in the fifth state, performing the display process for the first consumable and performing the display process for the second consumable.

8. The image recording apparatus according to claim 7, wherein the selectively performing the display process or the non-display process includes:
in a case where the second consumable is in the fourth state or the second consumable is already ordered, performing the display process for the first consumable and performing the non-display process for the second consumable; and
in a case where the second consumable is in the fifth state and the second consumable is not ordered yet, performing the display process for the first consumable and performing the display process for the second consumable.

9. The image recording apparatus according to claim 7, wherein the selectively performing the display process or the non-display process includes:
in a case where the first consumable is already ordered, performing the non-display process for the first consumable and the second consumable.

10. The image recording apparatus according to claim 7, wherein the controller is configured to control the display to display the order screen in which a determination operation object is displayed, the determination operation object being for determining whether to order at least one consumable for which identification information is displayed in the order screen.

11. The image recording apparatus according to claim 7, wherein the controller is configured to control the display to display the order screen in which a selection operation object is displayed, the selection operation object being for selecting, as a target to be ordered, at least one consumable for which identification information is displayed in the order screen.

12. The image recording apparatus according to claim 11, further comprising a third consumable,
wherein the controller is configured to:
determining which of a seventh state, an eighth state, and a ninth state a consumption level of the third consumable corresponds to, a consumption level of the eighth state being higher than the consumption level of the seventh state, a consumption level of the ninth state being higher than the consumption level of the eighth state;
control the display to display the selection operation object, for the first consumable in the third state and the second consumable in the fifth state, in the order screen in a state where selection is made as the target to be ordered;
in a case where the consumption level of the third consumable is the seventh state, control the display to display the selection operation object for the third consumable in the order screen in a state where selection is not made as the target to be ordered; and
in a case where the consumption level of the third consumable is the eighth state or the ninth state, control the display to display the selection operation object for the third consumable in the order screen in a state where selection is made as the target to be ordered.

13. The image recording apparatus according to claim 8, wherein the controller is configured to:
control the display to display an order status object in the order screen, the order status object indicating whether at least one consumable for which identification information is displayed has already been ordered.

14. The image recording apparatus according to claim 7, wherein a first threshold of a first consumption state amount is set as a threshold corresponding to a boundary between the second state and the third state, the first consumption state amount indicating the consumption level of the first consumable relative to an expected life of the first consumable;
wherein a second threshold of a second consumption state amount is set as a threshold corresponding to a boundary between the fifth state and the sixth state, the second consumption state amount indicating the consumption level of the second consumable relative to an expected life of the second consumable; and
wherein the controller is configured to:
in a case where the first consumption state amount of the first consumable reaches the first threshold, determine that the consumption level of the first consumable changes from the second state to the third state; and
in a case where the second consumption state amount of the second consumable reaches the second threshold, determine that the consumption level of the second consumable changes from the fifth state to the sixth state.

15. The image recording apparatus according to claim 7, wherein each of the at least two consumables is an ink cartridge, a waste liquid tank configured to store used ink, a recording head, a cutter configured to cut a recording medium, or a recording medium.

16. The image recording apparatus according to claim 7, wherein each of the at least two consumables is a toner cartridge, a waste toner box configured to store used toner, a development cartridge, a process cartridge, a drum unit, a belt unit, or a recording medium.

17. A non-transitory computer-readable storage medium storing a consumable order processing program including a set of program instructions for an external apparatus connected to an image recording apparatus, the external apparatus comprising a controller, the set of program instructions, when executed by the controller, causing the external apparatus to perform:
acquiring first information from the image recording apparatus, the image recording apparatus including at least two consumables including a first consumable and a second consumable and configured to record an image on a recording medium, the first information indicating which of a first state, a second state, and a third state a consumption level of the first consumable corresponds to, a consumption level of the second state being higher than the consumption level of the first state, a consumption level of the third state being higher than the consumption level of the second state;
acquiring second information from the image recording apparatus, the second information indicating which of a fourth state, a fifth state, and a sixth state a consumption level of the second consumable corresponds to, a consumption level of the fifth state being higher than the consumption level of the fourth state, a consumption level of the sixth state being higher than the consumption level of the fifth state; and
in a case where the first consumable becomes the third state before the second consumable becomes the sixth state, selectively performing an order process or a non-order process for the first consumable and the second consumable based on the first information and the second information,
the selectively performing the order process or the non-order process including:
in a case where the second consumable is in the fourth state, performing the order process for the first consumable and performing the non-order process for the second consumable; and
in a case where the second consumable is in the fifth state, performing the order process for the first consumable and performing the order process for the second consumable.

18. A non-transitory computer-readable storage medium storing a consumable order processing program including a set of program instructions for an external apparatus connected to an image recording apparatus, the external apparatus comprising a display and a controller, the set of program instructions, when executed by the controller, causing the external apparatus to perform:
acquiring first information from the image recording apparatus, the image recording apparatus including at least two consumables including a first consumable and a second consumable and configured to record an image on a recording medium, the first information indicating which of a first state, a second state, and a third state a consumption level of the first consumable corresponds to, a consumption level of the second state being higher than the consumption level of the first state, a consumption level of the third state being higher than the consumption level of the second state;
acquiring second information from the image recording apparatus, the second information indicating which of a fourth state, a fifth state, and a sixth state a consumption level of the second consumable corresponds to, a consumption level of the fifth state being higher than the consumption level of the fourth state, a consumption level of the sixth state being higher than the consumption level of the fifth state; and
in a case where the first consumable becomes the third state before the second consumable becomes the sixth state, selectively performing a display process or a non-display process in an order screen of the display for the first consumable and the second consumable based on the first information and the second information,
the selectively performing the display process or the non-display process including:
in a case where the second consumable is in the fourth state, performing the display process for the first consumable and performing the non-display process for the second consumable; and
in a case where the second consumable is in the fifth state, performing the display process for the first consumable and performing the display process for the second consumable.
